(19) United States
(12) Patent Application Publication
(10) Pub. No.: US 2024/0227020 A1
(43) Pub. Date: Jul. 11, 2024

(54) OBJECT SINTERING STATES

(71) Applicant: HAWLETT-PACKARD DEVELOPMENT COMPANY, L.P., Spring, TX (US)

(72) Inventors: Lei Chen, Shanghai (CN); Calos Alberto LOPEZ COLLIER DE LA MARLIERE, Guadalajara, JAL (MX); Chuang GAN, Shanghai (CN); Zi-Jiang YANG, Shanghai (CN); Yu XU, Shanghai (CN); Jun ZENG, Palo Alto, CA (US)

(73) Assignee: HAWLETT-PACKARD DEVELOPMENT COMPANY, L.P., Spring, TX (US)

(21) Appl. No.: 18/558,990

(22) PCT Filed: May 4, 2021
(86) PCT No.: PCT/US2021/030662

§ 371 Date: Nov. 3, 2023

(51) Int. Cl. B22F 10/85; B22F 10/14

(52) U.S. Cl. CPC B22F 10/85; B22F 10/14

(57) ABSTRACT

Examples of methods are described herein. In some examples, a method includes simulating, using a physics simulation engine, a first sintering state of an object at a first time. In some examples, the method includes predicting, using a machine learning model, a second sintering state of the object at a second time based on the first sintering state. In some examples, a prediction increment between the first time and the second time is different from a simulation increment.

### BACKGROUND

Three-dimensional (3D) solid parts may be produced from a digital model using additive manufacturing. Additive manufacturing may be used in rapid prototyping, mold generation, mold master generation, and short-run manufacturing. Additive manufacturing involves the application of successive layers of build material. This is unlike some machining processes that often remove material to create the final part. In some additive manufacturing techniques, the build material may be cured or fused.

### BRIEF DESCRIPTION OF THE DRAWINGS

FIG. 1 is a flow diagram illustrating an example of a method for determining object sintering states;

FIG. 2 is a diagram illustrating an example of a graph of displacement and temperature in accordance with some of the techniques described herein;

FIG. 3 is a block diagram of an example of an apparatus that may be used in determining object sintering states;

FIG. 4 is a block diagram illustrating an example of a computer-readable medium for determining object sintering states;

FIG. 5 is a diagram illustrating an example of a machine learning model architecture that may be utilized in accordance with some of the techniques described herein; and

FIG. 6 is a diagram illustrating an example of a machine learning architecture that may be utilized in accordance with some examples of the techniques described herein.

### DETAILED DESCRIPTION

Additive manufacturing may be used to manufacture three-dimensional (3D) objects. 3D printing is an example of additive manufacturing. Metal printing (e.g., metal binding printing, Metal Jet Fusion, etc.) is an example of 3D printing. In some examples, metal powder may be glued at certain voxels. A voxel is a representation of a location in a 3D space (e.g., a component of a 3D space). For instance, a voxel may represent a volume that is a subset of the 3D space. In some examples, voxels may be arranged on a 3D grid. For instance, a voxel may be cuboid or rectangular prismatic in shape. In some examples, voxels in the 3D space may be uniformly sized or non-uniformly sized. Examples of a voxel size dimension may include 25.4 millimeters (mm)/150-170 microns for 150 dots per inch (dpi), 490 microns for 50 dpi, 2 mm, 4 mm, etc. The term “voxel level” and variations thereof may refer to a resolution, scale, or density corresponding to voxel size.

Some examples of the techniques described herein may be utilized for various examples of additive manufacturing. For instance, some examples may be utilized for metal printing. Some metal printing techniques may be powder-based and driven by powder gluing and/or sintering. Some examples of the approaches described herein may be applied to area-based powder bed metal printing, such as binder jet, Metal Jet Fusion, and/or metal binding printing, etc. Some examples of the approaches described herein may be applied to additive manufacturing where an agent or agents (e.g., latex) carried by droplets are utilized for voxel-level powder binding.

In some examples, metal printing may include two phases. In a first phase, the printer (e.g., print head, carriage, agent dispenser, and/or nozzle, etc.) may apply an agent or agents (e.g., binding agent, glue, latex, etc.) to loose metal powder layer-by-layer to produce a glued precursor (or “green”) object. A precursor object is a mass of metal powder and adhesive. In a second phase, a precursor part may be sintered (e.g., heated) to produce an end object. For example, the glued precursor object may be placed in a furnace or oven to be sintered to produce the end object. Sintering may cause the metal powder to fuse, and/or may cause the agent to be burned off. An end object is an object formed from a manufacturing procedure or procedures. In some examples, an end object may undergo a further manufacturing procedure or procedures (e.g., support removal, polishing, assembly, painting, finishing, etc.). A precursor object may have an approximate shape of an end object.

The two phases of some examples of metal printing may present challenges in controlling the shape (e.g., geometry) of the end object. For example, the application (e.g., injection) of agent(s) (e.g., glue, latex, etc.) may lead to porosity in the precursor part, which may significantly influence the shape of the end object. In some examples, metal powder fusion (e.g., fusion of metal particles) may be separated from a layer-by-layer printing procedure, which may limit control over sintering and/or fusion.

In some examples, metal sintering may be performed in approaches for metal injection molded (MIM) objects and/or binder jet (e.g., MetJet). In some cases, metal sintering may introduce a deformation and/or change in an object varying from 25% to 50% depending on precursor object porosity. A factor or factors causing the deformation (e.g., visco-plasticity, sintering pressure, yield surface parameters, yield stress, and/or gravitational sag, etc.) may be captured and applied for shape deformation simulation. Some approaches for metal sintering simulation may provide science-driven simulation based on first principle sintering physics. For instance, factors including thermal profile and/or yield curve may be utilized to simulate object deformation due to shrinkage and/or sagging, etc. In some approaches, metal sintering simulation may provide science driven prediction of an object deformation and/or compensation for the deformation. Some simulation approaches may provide relatively high accuracy results at a voxel level for a variety of geometries (e.g., from less to more complex geometries). Due to computational complexity, some examples of physics-based simulation engines may take a relatively long period to complete a simulation. For instance, simulating transient and dynamic sintering of an object may take from tens of minutes to several hours depending on object size. In some examples, larger object sizes may increase simulation runtime. For example, a 12.5 centimeter (cm) object may take 218.4 minutes to complete a simulation run. Some examples of physics-based simulation engines may utilize relatively small increments (e.g., time periods) in simulation to manage the nonlinearity that arises from the sintering physics. Accordingly, it may be helpful to reduce simulation time.

Some examples of the techniques described herein may utilize a machine learning model or models. Machine learning is a technique where a machine learning model is trained to perform a task or tasks based on a set of examples (e.g., data). Training a machine learning model may include determining weights corresponding to structures of the machine learning model. Artificial neural networks are a kind of machine learning model that are structured with nodes, model layers, and/or connections. Deep learning is a kind of machine learning that utilizes multiple layers. A deep neural network is a neural network that utilizes deep learning.

Examples of neural networks include convolutional neural networks (CNNs) (e.g., basic CNN, deconvolutional neural network, inception module, residual neural network, etc.) and recurrent neural networks (RNNs) (e.g., basic RNN, multi-layer RNN, bi-directional RNN, fused RNN, clockwork RNN, etc.). Different depths of a neural network or neural networks may be utilized in accordance with some examples of the techniques described herein.

In some examples of the techniques described herein, deep learning may be utilized to build out a quantitative model that may be used with simulation approaches to replace partial intermediate simulation periods. In some examples, a deep neural network may infer a sintering state. A sintering state is data representing a state of an object in a sintering procedure. For instance, a sintering state may indicate a characteristic or characteristics of the object at a time during the sintering procedure. In some examples, a sintering state may indicate a physical value or values associated with a voxel or voxels of an object. Examples of a characteristic(s) that may be indicated by a sintering state may include displacement, porosity, and/or displacement rate of change, etc. Displacement is an amount of movement (e.g., distance) for all or a portion (e.g., voxel(s)) of an object. For instance, displacement may indicate an amount and/or direction that a part of an object has moved during sintering over a time period (e.g., since beginning a sintering procedure). Displacement may be expressed as a displacement vector or vectors at a voxel level. Porosity is a proportion of empty volume or unoccupied volume for all or a portion (e.g., voxel(s)) of an object. A displacement rate of change is a rate of change (e.g., velocity) of displacement for all or a portion (e.g., voxel(s)) of an object.

A time period spanned in a prediction (by a machine learning model or models, for instance) may be referred to as a prediction increment. For example, a deep neural network may infer a sintering state at time T2 based on a sintering state (e.g., displacement) at time T1, where T1<T2. A time period spanned in simulation may be referred to as a simulation increment. In some examples, a prediction increment (e.g., T2−T1) may be greater than the simulation increment. In some examples, T1−k*dt and T2=(k+n)*dt, where T1 is a first time (e.g., prediction start time), T2 is a second time, k is a time index at the first time, n represents a quantity of simulation increments, and dt represents an amount of time of a simulation increment. In some examples, n>>1. For instance, a prediction increment may span and/or replace many simulation increments.

In some examples, a prediction of a sintering state at T2 may be based on a simulated sintering state at T1. For instance, a simulated sintering state at T1 may be utilized as input to a machine learning model to predict a sintering state at T2. Predicting a sintering state using a machine learning model may be performed more quickly than simulating a sintering state. For example, predicting a sintering state at T2 may be performed in less than a second, which may be faster than determining the sintering state at T2 through simulation. For instance, a relatively large number of simulation increments may be utilized, and each simulation increment may take approximately a minute to complete. Utilizing prediction (e.g., machine learning, inferencing, etc.) to replace some simulation increments may enable determining a sintering state in less time (e.g., more quickly). For example, utilizing machine learning (e.g., a deep learning inferencing engine) in conjunction with simulation may allow larger (e.g., ×10) increments (e.g., prediction increments) to increase processing speed while preserving accuracy.

In some examples, sintering state prediction (e.g., inferencing from T1 to T2) may not be extremely accurate (e.g., may be less accurate than sintering state simulation). In some examples, the predicted sintering state may be tuned to achieve an accuracy target. For instance, a physics simulation engine may utilize an iterative tuning procedure to achieve an accuracy target and/or to increase the accuracy of the predicted (e.g., inferred) sintering state at T2.

Some examples of the techniques described herein may be performed in an offline loop. An offline loop is a procedure that is performed independent of (e.g., before) manufacturing, without manufacturing the object, and/or without measuring (e.g., scanning) the manufactured object.

Throughout the drawings, identical reference numbers may or may not designate similar or identical elements. Similar numbers may or may not indicate similar elements. When an element is referred to without a reference number, this may refer to the element generally, with or without limitation to any particular drawing or figure. The drawings are not necessarily to scale, and the size of some parts may be exaggerated to more clearly illustrate the example shown. Moreover, the drawings provide examples in accordance with the description. However, the description is not limited to the examples provided in the drawings.

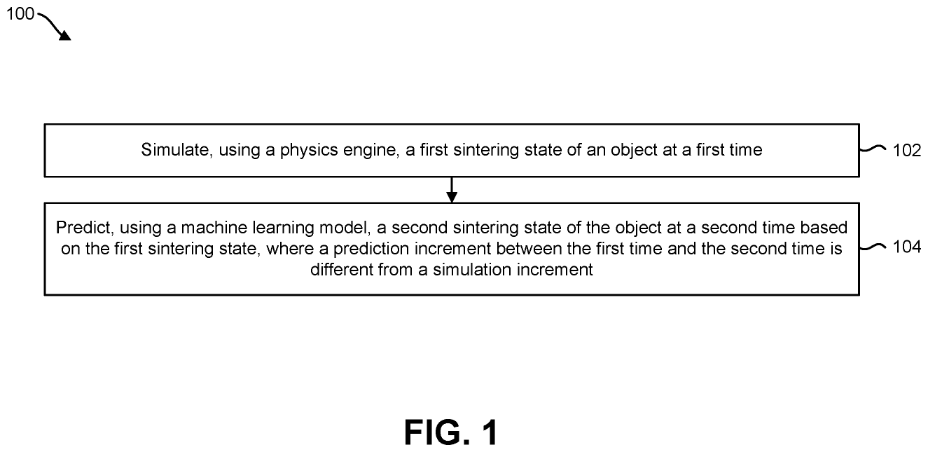

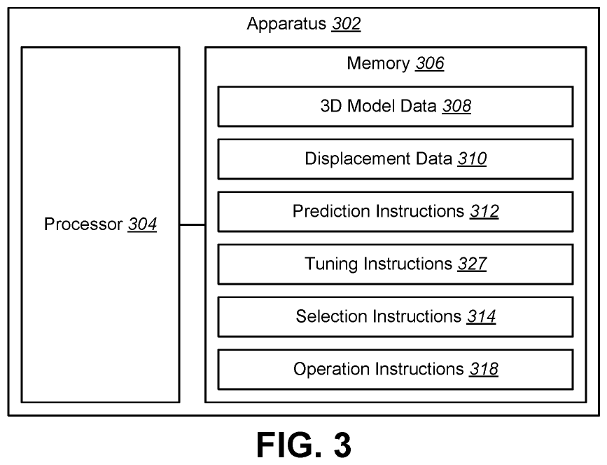

FIG. 1 is a flow diagram illustrating an example of a method 100 for determining object sintering states. The method 100 and/or an element or elements of the method 100 may be performed by an apparatus (e.g., electronic device). For example, the method 100 may be performed by the apparatus 302 described in connection with FIG. 3.

The apparatus may simulate 102, using a physics engine, a first sintering state of an object at a first time. The object may be represented by an object model and/or may be planned for manufacture. An object model is a geometrical model of an object. For instance, an object model may be a three-dimensional (3D) model representing an object. Examples of object models include computer-aided design (CAD) models, mesh models, 3D surfaces, etc. An object model may be expressed as a set of points, surfaces, faces, vertices, etc. In some examples, the apparatus may receive an object model from another device (e.g., linked device, networked device, removable storage, etc.) or may generate the 3D object model.

A physics engine is hardware (e.g., circuitry) or a combination of instructions and hardware (e.g., a processor with instructions) to simulate a physical phenomenon or phenomena. In some examples, the physics engine may simulate material (e.g., metal) sintering. For example, the physics engine may simulate physical phenomena on an object (e.g., object model) over time (e.g., during sintering). The simulation may indicate deformation effects (e.g., shrinkage, sagging, etc.). In some examples, the physics engine may simulate sintering using a finite element analysis (FEA) approach.

Some examples of the physics engine may utilize a time-marching approach. Starting at an initial time T0, the physics engine may simulate and/or process a simulation increment (e.g., a period of time, dt, etc.). In some examples, the simulation increment may be indicated by received input. For instance, the apparatus may receive an input from a user indicating the simulation increment. In some examples, the simulation increment may be selected randomly, may be selected from a range, and/or may be selected empirically.

In some examples, the physics simulation engine may utilize trial displacements. A trial displacement is an estimate of a displacement that may occur during sintering. Trial displacements may be produced by a machine learning model and/or with another function (e.g., random selection and/or displacement estimating function, etc.). In some examples, trial displacements may be denoted D0. The trial displacements (e.g., trial displacement field) may trigger imbalances of the forces involved in sintering process. In some examples, the physics simulation engine may include and/or utilize an iterative optimization technique to iteratively re-shape displacements initialized by D0 such that force equilibrium is achieved. In some examples, the physics simulation engine may produce a displacement field (e.g., equilibrium displacement field that may be denoted De) as the first sintering state at the first time (e.g., T1, T0+dt).

The apparatus may predict 104, using a machine learning model, a second sintering state of the object at a second time based on the first sintering state, where a prediction increment between the first time (e.g., T1) and the second time (e.g., T2) is different from a simulation increment (e.g., dt). For instance, the prediction increment may be unequal to the simulation increment, greater than the simulation increment, less than the simulation increment, not matched to the simulation increment, etc. As described herein, for example, the prediction increment (e.g., T2−T1) may be greater (e.g., a longer time period) than the simulation increment (e.g., dt). For instance, the prediction increment may span a greater time period than the simulation increment. In some examples, the prediction increment may be less than (e.g., smaller than) the simulation increment. In some examples, the difference between the prediction increment and the simulation increment may trigger a non-equilibrium of forces. The physics simulation engine may be utilized to iteratively reshape the second sintering state (e.g., second D0) to an equilibrium state (e.g., equilibrium displacement field, De), where equilibrium is achieved.

In some examples, after getting a predicted output (e.g., predicted sintering state) from the machine learning model, the apparatus may feed the predicted output back into the physics engine. For instance, the physics engine may utilize the predicted output as a trial displacement or displacements that may trigger force imbalances to iteratively reshape trial displacements (e.g., D0). As described herein, a force equilibrium may be achieved, and the physics simulation engine may be utilized to compute an equilibrium displacement field (e.g., De). In some examples, the method 100 may include repeating (e.g., recursively performing) sintering state simulation and sintering state prediction (e.g., iterating between 102 and 104).

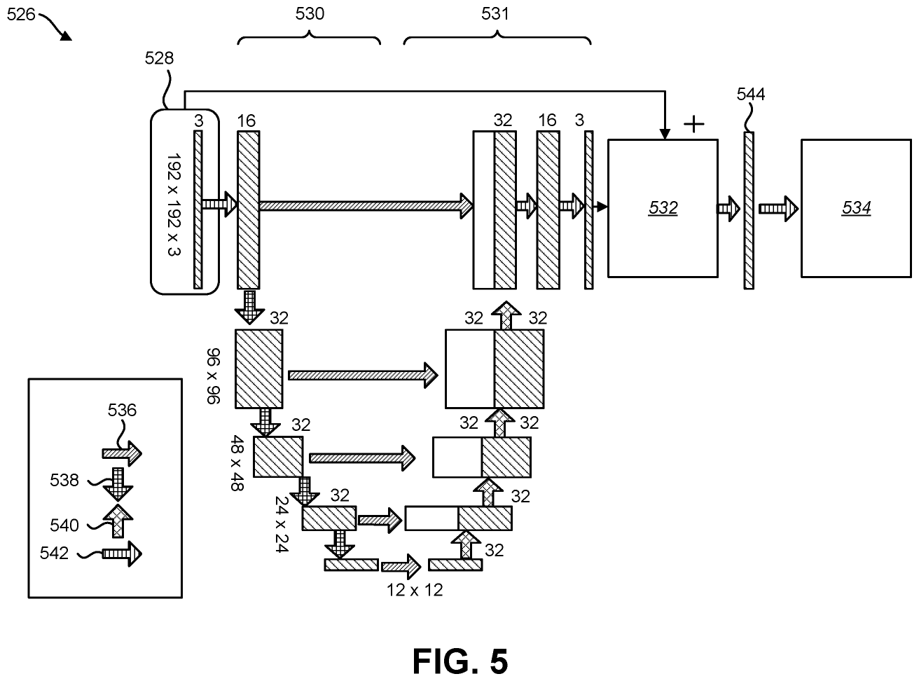

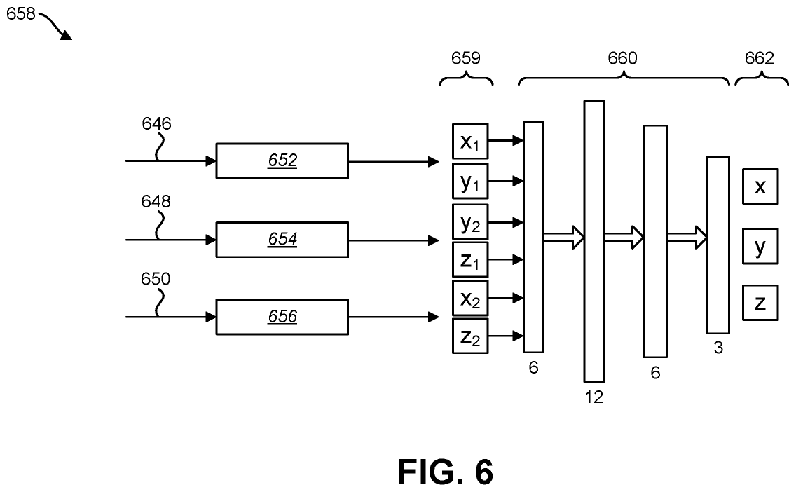

The machine learning model may be trained using training data from a training simulation or simulations. For example, the machine learning model may utilize a first training sintering state (e.g., displacement, displacement rate of change, etc.) at a first training time as input and a second training sintering state (e.g., displacement, displacement rate of change, etc.) at a second training time as ground truth during training. Examples of machine learning model architectures that may be utilized in accordance with the techniques described herein are given in relation to FIG. 5 and FIG. 6. For instance, the machine learning model may be neural network(s), CNN(s), etc. In some examples, a machine learning architecture may include respective machine learning models for predicting respective plane sintering states (e.g., x-y plane sintering state, y-z plane sintering state, and x-z plane sintering state), which may be fused to produce a 3D sintering state. For instance, the apparatus may utilize the plane machine learning models described in relation to FIG. 6 to predict 104 a sintering state.

In some examples, multiple machine learning models may be utilized. For example, respective machine learning models may be trained for respective sintering stages. A sintering stage is a period during a sintering procedure. For example, a sintering procedure may include multiple sintering stages (e.g., 2, 3, 4, etc., sintering stages). In some examples, each sintering stage may correspond to different circumstances (e.g., different temperatures, different heating patterns, different periods during the sintering procedure, etc.). For instance, sintering dynamics at different temperatures and/or sintering stages may have different deformation rates. Multiple machine learning models (e.g., deep learning models) may be trained to be tailored to different sintering stages. In some examples, the machine learning models may have a fixed prediction increment at a time (e.g., a prediction increment at time TA to time TB) when deployed. A fixed prediction increment may be useful for defined sintering temperature schedules.

In some examples, each machine learning model may be trained using corresponding sintering stage data. For instance, the respective machine learning models may be trained with different training data. For example, the machine learning model may be trained with data from a first stage of a training simulation and a second machine learning model may be trained with data from a second stage of the training simulation (and/or another training simulation). In some examples, machine learning models corresponding to different sintering stages may have similar or the same architectures and/or may be trained with different training data.

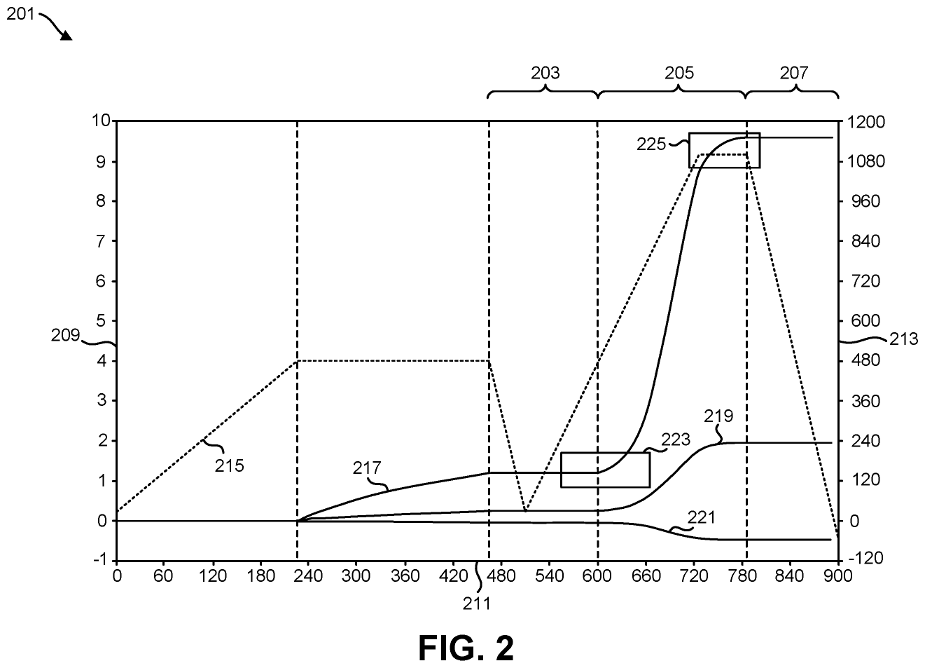

In some examples, the machine learning model may be trained for a prediction or predictions during a first sintering stage and a second machine learning model may be trained for a prediction or predictions during a second sintering stage. For instance, the machine learning model may be utilized to predict the second sintering state in the first sintering stage. The method 100 may include predicting, using a second machine learning model, a third sintering state (e.g., subsequent sintering state) of the object in a second sintering stage. An example of sintering stages is given in relation to FIG. 2.

In some examples, simulating 102 and/or predicting 104 sintering states may be performed in a voxel space in some approaches. A voxel space is a plurality of voxels. In some examples, a voxel space may represent a build volume and/or a sintering volume. A build volume is a 3D space for object manufacturing. For example, a build volume may represent a cuboid space in which an apparatus (e.g., computer, 3D printer, etc.) may deposit material (e.g., metal powder, metal particles, etc.) and agent(s) (e.g., glue, latex, etc.) to manufacture an object (e.g., precursor object). In some examples, an apparatus may progressively fill a build volume layer-by-layer with material and agent during manufacturing. A sintering volume may represent a 3D space for object sintering (e.g., oven). For instance, a precursor object may be placed in a sintering volume for sintering. In some examples, a voxel space may be expressed in coordinates. For example, locations in a voxel space may be expressed in three coordinates: x (e.g., width), y (e.g., length), and z (e.g., height).

In some examples, a sintering state may indicate a displacement in a voxel space. For instance, the second sintering state may indicate a displacement (e.g., displacement vector(s), displacement field(s), etc.) in voxel units and/or coordinates. In some examples, the second sintering state may indicate a position of a point or points of the object at the second time, where the point or points of the object at the second time correspond to a point or points of the object at the first time (and/or at a time previous to the first time). A displacement vector may indicate a distance and/or direction of movement of a point of the object over time. For instance, a displacement vector may be determined as a difference (e.g., subtraction) between positions of a point over time (in a voxel space, for instance).

In some examples, a sintering state may indicate a displacement rate of change (e.g., displacement “velocity”). For instance, a machine learning model may produce a sintering state that indicates the rate of change of the displacements. For example, a machine learning model (e.g., deep learning model for inferencing) may take an increment (e.g., prediction increment) as an input (e.g., dynamic input), and may work with different temperature control curves. In some examples, multiple machine learning models (e.g., velocity-based deep learning models) may be trained capturing different sintering dynamics.

In some examples, the method 100 may include tuning, using the physics simulation engine, a sintering state (e.g., the second sintering state). For instance, the machine learning model may predict (e.g., infer) the second sintering state. The predicted sintering state may not be as accurate as a simulated sintering state would be. The physics simulation engine may perform an iterative tuning procedure to tune the second sintering state, which may increase sintering state accuracy. In some examples, the predicted sintering state (e.g., the second sintering state) may indicate trial displacements and/or a trial displacement field (e.g., D0) for the simulation. In some examples, the trial displacements and/or trial displacement field (e.g., D0) may be relatively close to the equilibrium displacement field (e.g., De). This may allow a prediction increment to be utilized that is greater than a simulation increment. For instance, if D0 is relatively close to De, the iterative tuning may be utilized to efficiently converge the displacement field(s) to De. This may help to achieve faster computation and/or to provide similar sintering state accuracy to that of a physics simulation engine.

In some examples, the method 100 may include determining and/or selecting a machine learning model. For instance, the apparatus may determine when to switch between machine learning models for different stages. In some examples, switching between machine learning models may be based on a set time and/or a set temperature. For instance, the apparatus may switch from a machine learning model for a first stage to a second machine learning model for a second stage at 600 minutes in simulated time and/or at 145 degrees Celsius (° C.) in simulated temperature. Other times and/or temperatures may be utilized in some examples.

In some examples, the method 100 may include determining and/or selecting a machine learning model using a transition region. A transition region is a region (in terms of time and/or temperature range(s), for instance) in a sintering procedure where a switch in machine learning models may occur. For example, for a transition from a first sintering stage to a second sintering stage, a first transition region may be between 100-200° C. For a transition from a second sintering stage to a third sintering state, a second transition region may be between 1000-1100° C. For example, the apparatus may check whether the current simulated time and/or simulated temperature is in a sintering stage Sind (e.g., sintering stage outside of a transition region). If the current simulated time and/or simulated temperature is in a sintering stage Sind (where “ind” denotes an index for sintering stages and/or machine learning models, for instance), the apparatus may utilize the machine learning model M_{ind} corresponding to the stage Sind. If the current simulated time and/or simulated temperature is in a transition region Rind, the apparatus may execute two machine learning models M_{ind} and M_{ind+1}. The apparatus may determine residual losses corresponding to the machine learning models. A residual loss indicates a difference or error between a predicted sintering state and a final sintering state (e.g., tuned sintering state, tuned displacement, etc.). The apparatus may select a machine learning model corresponding to a lesser residual loss. The selected machine learning model may be utilized for the transition region. In some examples, multiple machine learning model selections may be carried out in the transition region. For instance, the apparatus may select between M_{ind} and M_{ind+1}. Once M_{ind+1} has been selected, M_{ind+1} may be utilized for the rest of the transition region and/or in the sintering stage after the transition region until a next transition or transition region.

In some examples, the apparatus may predict, using the machine learning model, a first candidate sintering state in a transition region. The apparatus may predict, using a second machine learning model, a second candidate sintering state in the transition region. The apparatus may determine a first residual loss based on the first candidate sintering state and a second residual loss based on the second candidate sintering state. The apparatus may select the machine learning model or the second machine learning model based on the first residual loss and the second residual loss. In some examples, determining the first residual loss may include determining a first difference of the first candidate sintering state and a tuned sintering state. Determining the second residual loss may include determining a second difference of the second candidate sintering state and the tuned sintering state. Selecting the machine learning model or the second machine learning model may include comparing the first residual loss and the second residual loss (e.g., determining which quantity is lesser and/or greater). The apparatus may select the machine learning model associated with the lesser residual loss.

In some examples, the apparatus may utilize a selection machine learning model to select a machine learning model (e.g., to select a machine learning model, second machine learning model, third machine learning model, etc.) for sintering stages. For instance, the method 100 may include selecting the machine learning model or a second machine learning model based on a selection machine learning model. In some examples, a selection machine learning model may detect a sintering stage. For example, the selection machine learning model may be a CNN trained to learn a sintering stage or stages. For instance, machine learning model selection may be managed based on a machine learning model trained to classify a sintering stage or stages. In some examples, the selection machine learning model may utilize time, temperature, and/or other related information as input for each increment. The selection machine learning model may be trained with a target sintering stage class. At inference time, for example, with the calling time and/or temperature, the trained selection machine learning model may output a corresponding sintering stage index number (e.g., ind), which may be used to select a corresponding machine learning model (e.g., deep learning model).

In some examples, an element or elements of the method 100 may recur, may be repeated, and/or may be iterated. For instance, the apparatus may simulate a subsequent sintering state or states, and/or the apparatus may predict a subsequent sintering state or states. An iteration is an instance of a repetitive procedure or loop. For example, an iteration may include a sequence of operations that may iterate and/or recur. For instance, an iteration may be a series of executed instructions in a loop.

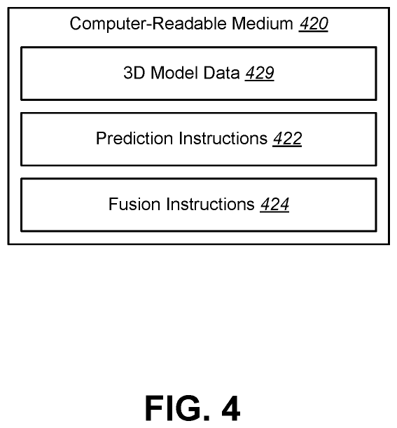

In some examples, operation(s), function(s), and/or element(s) of the method 100 may be omitted and/or combined. In some examples, the method 100 may include one, some, or all of the operation(s), function(s), and/or element(s) described in relation to FIG. 2, FIG. 3, FIG. 4, FIG. 5, and/or FIG. 6.

FIG. 2 is a diagram illustrating an example of a graph 201 of displacement and temperature in accordance with some of the techniques described herein. For example, the graph 201 illustrates examples of an x-axis displacement 217, a y-axis displacement 219, and a z-axis displacement 221 corresponding to displacement at a point of maximum deformation in a shape deformation simulation. The x-axis displacement 217, y-axis displacement 219, and z-axis displacement 221 are illustrated in displacement in millimeters (mm) 209 over time in minutes 211 (in simulated time, for instance). Sintering procedure temperature 215 is illustrated in temperature in ° C. 213 over time in minutes 211 (in simulated time, for instance).

As illustrated in the graph 201, a sintering procedure may include applying varying temperatures to cause an object to sinter. The object may experience deformation during the sintering procedure.

Examples of sintering stages are illustrated in FIG. 2. For example, the sintering procedure may include a first sintering stage 203, a second sintering stage 205, and a third sintering stage 207 (e.g., equilibrium stage). The first sintering stage 203 may have an associated time and/or temperature (e.g., 470-600 minutes), the second sintering stage 205 may have an associated time and/or temperature (e.g., 600-785 minutes), and the third sintering stage may have an associated time and/or temperature (e.g., 785-900 minutes). In some examples, more or fewer sintering stages may be utilized. In some examples, a respective machine learning model may be trained for each of the sintering stages. For example, a machine learning model may be trained for the first sintering stage 203, a second machine learning model may be trained for the second sintering stage 205, and a third machine learning model may be trained for the third sintering stage 207. For instance, the simulation procedure may be partitioned into three sintering stages, where each sintering stage may have a respective machine learning model (e.g., deep learning model) based on sintering temperature profile, object geometry and/or material.

In some examples, the machine learning models may be selected based on the stage (e.g., based on stage times and/or temperatures). For instance, an apparatus may select a machine learning model corresponding to a stage if the simulated time is within a time range of that stage and/or if a simulated temperature is within a temperature range of that stage.

In some examples, exact time and/or temperature points corresponding to the stages may not provide optimal switching triggers due to the variation for each sintering procedure's temperature profile, varying object geometry, etc. In some examples, a transition region or regions may be utilized. FIG. 2 illustrates examples of a first transition region 223 (for a transition from the first sintering stage 203 to the second sintering stage 205) and a second transition region 225 (for a transition from the second sintering stage 205 to the third sintering stage 207). For instance, an apparatus may utilize a machine learning model to predict a sintering state during the first sintering stage 203 (outside of the first transition region 223, for example). While in the first transition region 223, the apparatus may utilize the machine learning model to predict a first candidate sintering state and a second machine learning model to predict a second candidate sintering state. The apparatus may determine a tuned sintering state or states based on the first candidate sintering state and/or the second candidate sintering state. The apparatus may determine a first residual loss between the first candidate sintering state and the tuned sintering state. The apparatus may determine a second residual loss between the second candidate sintering state and the tuned sintering state. The apparatus may select the machine learning model associated with the lesser residual loss. For example, once the second machine learning model produces a second candidate sintering state with a lesser residual loss, the apparatus may switch to the second machine learning model and/or may utilize the second machine learning model during the second sintering stage 205 until the second transition region 225. In the second transition region, the apparatus may similarly execute the second machine learning model and the third machine learning model to select the machine learning model associated with a lesser residual loss. The third machine learning model may be utilized in the remainder of the third sintering stage 207.

FIG. 3 is a block diagram of an example of an apparatus 302 that may be used in determining object sintering states. The apparatus 302 may be a computing device, such as a personal computer, a server computer, a printer, a 3D printer, a smartphone, a tablet computer, etc. The apparatus 302 may include and/or may be coupled to a processor 304 and/or a memory 306. The memory 306 may be in electronic communication with the processor 304. For instance, the processor 304 may write to and/or read from the memory 306. In some examples, the apparatus 302 may be in communication with (e.g., coupled to, have a communication link with) an additive manufacturing device (e.g., a 3D printing device). In some examples, the apparatus 302 may be an example of a 3D printing device. The apparatus 302 may include additional components (not shown) and/or some of the components described herein may be removed and/or modified without departing from the scope of this disclosure.

The processor 304 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions (e.g., prediction instructions 312 and/or selection instructions 314) stored in the memory 306. In some examples, the processor 304 may include an electronic circuit or circuits that include electronic components for performing a functionality or functionalities of the instructions (e.g., prediction instructions 312, tuning instructions 327, and/or selection instructions 314). In some examples, the processor 304 may perform one, some, or all of the functions, operations, elements, methods, etc., described in connection with one, some, or all of FIGS. 1-6.

The memory 306 may be any electronic, magnetic, optical, and/or other physical storage device that contains or stores electronic information (e.g., instructions and/or data). Thus, the memory 306 may be, for example, Random Access Memory (RAM), Electrically Erasable Programmable Read-Only Memory (EEPROM), a storage device, an optical disc, and/or the like. In some implementations, the memory 306 may be a non-transitory tangible machine-readable storage medium, where the term “non-transitory” does not encompass transitory propagating signals.

In some examples, the apparatus 302 may also include a data store (not shown) on which the processor 304 may store information. The data store may be volatile and/or non-volatile memory, such as Dynamic Random Access Memory (DRAM), EEPROM, magnetoresistive random-access memory (MRAM), phase change RAM (PCRAM), memristor, flash memory, and the like. In some examples, the memory 306 may be included in the data store. In some examples, the memory 306 may be separate from the data store. In some approaches, the data store may store similar instructions and/or data as that stored by the memory 306. For example, the data store may be non-volatile memory and the memory 306 may be volatile memory.

In some examples, the apparatus 302 may include an input/output interface (not shown) through which the processor 304 may communicate with an external device or devices (not shown), for instance, to receive and store the information pertaining to the object(s) for which a sintering state or states may be determined. The input/output interface may include hardware and/or machine-readable instructions to enable the processor 304 to communicate with the external device or devices. The input/output interface may enable a wired or wireless connection to the external device or devices. In some examples, the input/output interface may further include a network interface card and/or may also include hardware and/or machine-readable instructions to enable the processor 304 to communicate with various input and/or output devices, such as a keyboard, a mouse, a display, another apparatus, electronic device, computing device, etc., through which a user may input instructions into the apparatus 302. In some examples, the apparatus 302 may receive 3D model data 308 from an external device or devices (e.g., computer, removable storage, network device, etc.).

In some examples, the memory 306 may store 3D model data 308. The 3D model data 308 may be generated by the apparatus 302 and/or received from another device. Some examples of 3D model data 308 include a 3D manufacturing format (3MF) file or files, a 3D computer-aided design (CAD) image, object shape data, mesh data, geometry data, etc. The 3D model data 308 may indicate the shape of an object or objects. In some examples, the 3D model data 308 may indicate a packing of a build volume, or the apparatus 302 may arrange 3D object models represented by the 3D model data 308 into a packing of a build volume. In some examples, the 3D model data 308 may be utilized to obtain slices of a 3D model or models. For example, the apparatus 302 may slice the model or models to produce slices, which may be stored in the memory 306. In some examples, the 3D model data 308 may be utilized to obtain an agent map or agent maps of a 3D model or models. For example, the apparatus 302 may utilize the slices to determine agent maps (e.g., voxels or pixels where agent(s) are to be applied), which may be stored in the memory 306.

In some examples, the memory 306 may store displacement data 310. The displacement data 310 may indicate displacements (e.g., intermediate displacements). In some examples, the displacement data 310 may be produced by a machine learning model (e.g., D0 from a deep learning model prediction) and/or by a physics simulation engine (e.g., physics simulation engine output, De tuned by a physics simulation engine, etc.). In some examples, the displacement data 310 may be stored as image and/or visualization file or files. In some examples, the displacement data 310 may be stored separately from (e.g., independent of) the 3D model data 308.

The memory 306 may store prediction instructions 312. In some examples, the processor 304 may execute the prediction instructions 312 to predict, using a first machine learning model, a first sintering state of an object.

In some examples, this may be accomplished as described in relation to FIG. 1 and/or FIG. 2. For instance, the processor 304 may infer the sintering state (e.g., displacement, displacement rate of change, etc.) for an object represented by the 3D model data 308. In some examples, the first machine learning model may be trained using training data that includes a simulated input sintering state at a start time (e.g., a sintering state produced by a simulation at a first simulation time), and a simulated output sintering state at a target time (e.g., a sintering state produced by the simulation at a second simulation time). For instance, the simulated input sintering state may correspond to the start time, and the simulated output sintering state may correspond to the target time. In some examples, the simulated output sintering state may be a ground truth for training the first machine learning model. At inference time, the trained first machine learning model may use a simulated sintering state at a time to predict a simulated sintering state for a later time.

In some examples, the processor 304 may execute the prediction instructions 312 to predict, using a second machine learning model, a second sintering state of the object. In some examples, this may be accomplished as described in relation to FIG. 1 and/or FIG. 2. The first sintering state and the second sintering state may correspond to a same prediction increment. In some examples, the first machine learning model and/or the second machine learning model may utilize an architecture similar to the machine learning model architecture 526 described in relation to FIG. 5 and/or to the machine learning model architecture 658 described in relation to FIG. 6.

In some examples, the processor 304 may execute the tuning instructions 327 to tune the first sintering state and/or the second sintering state using a physics simulation engine to produce the tuned sintering state. In some examples, this may be accomplished as described in relation to FIG. 1 and/or FIG. 2.

The memory 306 may store selection instructions 314. In some examples, the processor 304 may execute the selection instructions 314 to select the first machine learning model or the second machine learning model based on the first sintering state, the second sintering state, and the tuned sintering state. In some examples, this may be accomplished as described in relation to FIG. 1 and/or FIG. 2. For instance, the apparatus 302 (e.g., processor 304) may determine a first residual loss based on the first sintering state and the tuned sintering state, and may determine a second residual loss based on the second sintering state and the tuned sintering state. The apparatus 302 (e.g., processor 304) may compare the residual losses and select the machine learning model associated with the smaller residual loss. For instance, the apparatus 302 (e.g., processor 304) may use the machine learning model that produced the sintering state (e.g., the first sintering state or the second sintering state) that is closer to the tuned sintering state.

The memory 306 may store operation instructions 318. In some examples, the processor 304 may execute the operation instructions 318 to perform an operation based on the sintering state (e.g., tuned sintering state). For example, the apparatus 302 may present the sintering state and/or a value or values associated with the sintering state (e.g., maximum displacement, displacement direction, an image of the object model with a color coding showing the degree of displacement over the object model, etc.) on a display, may store the sintering state and/or associated data in memory 306, and/or may send the sintering state and/or associated data to another device or devices. In some examples, the apparatus 302 may determine whether a sintering state (e.g., last or final sintering state) is within a tolerance (e.g., within a target amount of displacement). In some examples, the apparatus 302 may print a precursor object based on the object model if the sintering state is within the tolerance. For example, the apparatus 302 may print the precursor object based on two-dimensional (2D) maps or slices of the object model indicating placement of binder agent (e.g., glue). In some examples, the apparatus 302 (e.g., processor 304) may determine compensation based on the sintering state (e.g., series of sintering states and/or final sintering state). For instance, the apparatus 302 (e.g., processor 304) may adjust the object model to compensate for deformation (e.g., sag) indicated by the sintering state(s). For example, the object model may be adjusted in an opposite direction or directions from the displacement(s) indicated by the sintering state(s) to reduce deformation.

FIG. 4 is a block diagram illustrating an example of a computer-readable medium 420 for determining object sintering states. The computer-readable medium 420 may be a non-transitory, tangible computer-readable medium 420. The computer-readable medium 420 may be, for example, RAM, EEPROM, a storage device, an optical disc, and the like. In some examples, the computer-readable medium 420 may be volatile and/or non-volatile memory, such as DRAM, EEPROM, MRAM, PCRAM, memristor, flash memory, and/or the like. In some implementations, the memory 306 described in connection with FIG. 3 may be an example of the computer-readable medium 420 described in connection with FIG. 4.

The computer-readable medium 420 may include code (e.g., data and/or instructions, executable code, etc.). For example, the computer-readable medium 420 may include 3D model data 429, prediction instructions 422, and/or fusion instructions 424.

In some examples, the computer-readable medium 420 may store 3D model data 429. Some examples of 3D model data 429 include a 3D CAD file, a 3D mesh, etc. The 3D model data 429 may indicate the shape of a 3D object or 3D objects (e.g., object model(s)).

In some examples, the prediction instructions 422 are code to cause a processor to predict a first plane sintering state using a first plane machine learning model. For example, the first plane machine learning model may be an x-y machine learning model. The x-y machine learning model may be trained to predict a sintering state in an x-y plane.

In some examples, the prediction instructions 422 are code to cause a processor to predict a second plane sintering state using a second plane machine learning model. For example, the second plane machine learning model may be a y-z machine learning model. The y-z machine learning model may be trained to predict a sintering state in a y-z plane.

In some examples, the prediction instructions 422 are code to cause a processor to predict a third plane sintering state using a third plane machine learning model. For example, the third plane machine learning model may be an x-z machine learning model. The x-z machine learning model may be trained to predict a sintering state in an x-z plane.

In some examples, the fusion instructions 424 are code to cause a processor to fuse the first plane sintering state, the second plane sintering state, and the third plane sintering state to produce a 3D sintering state. For example, the first plane sintering state, the second plane sintering state, and the third plane sintering state may be fused. For instance, the information from the first plane sintering state, the second plane sintering state, and the third plane sintering state may be combined to produce a sintering state across x, y, and z dimensions. In some examples, the fusion instructions 424 may be based on a fusing network (e.g., a neural network trained to fuse the first plane sintering state, the second plane sintering state, and the third plane sintering state). An example of an architecture to predict x-y, y-z, and x-z sintering states (and to fuse the x-y, y-z, and x-z sintering states to produce a 3D sintering state, for instance) is given in relation to FIG. 6.

FIG. 5 is a diagram illustrating an example of a machine learning model architecture 526 that may be utilized in accordance with some of the techniques described herein. In some examples, the method 100 may utilize the architecture 526 to predict a sintering state or sintering states. In some examples, the apparatus 302 may utilize (e.g., the processor 304 may execute) the architecture 526 to predict sintering states. In some examples, the machine learning model architecture 526 may include a wrapping mechanism, a convolutional neural network, and/or a spatial transformer layer.

The architecture 526 may include an input layer 528, convolution layers, pooling layers, a difference field determination 532, and a wrap layer 544. In FIG. 5, the architecture takes layer copies 536 for concatenation, performs max pooling 538 (e.g., 2×2 max pooling), performs up-convolution 540, and performs convolution 542 (e.g., 3×3 convolution). In this example, the input layer 528 may take an input with dimensions of 192×192×3. In some examples, the input may be at a first time (e.g., t(m−n)), where t is time, m is an increment index at a second time or target time (e.g., t(m)), and n is a quantity of increments). The input may be a displacement. For instance, the displacement may be represented as a 3-channel image, where each color channel represents displacement on a respective axis (e.g., x, y, and z). FIG. 5 illustrates some examples of sizes and/or dimensions that may be utilized. In some examples, other sizes (e.g., layer dimensions and/or operation dimensions) may be utilized. For instance, a different architecture may be utilized. In some examples, the number of encoding and decoding stages may be adjusted and/or each encoding and/or decoding stage's number of feature maps may be adjusted, where concatenating layer dimensions are matched.

In some examples, the architecture 526 may be trained with a simulated sintering state at a start time to predict the corresponding layer sintering state (e.g., displacement value) at a target time, where target time simulation output data may be utilized as ground truth. From physical domain perspective, metal sintering may be a physical procedure where each metal particle is affected by neighboring particles with various forces involved, leading to the end-object deformation. A machine learning model (e.g., CNN) may be utilized to extract local features and higher level features of an image, learn a filter matrix and connection weights, and predict output feature mappings. Some machine learning models may preserve the input image structural integrity by passing the input and contraction portion feature layers (e.g., an encoder portion 530 of the architecture 526), concatenating with the expansion portion feature layers (e.g., a decoder portion 531 of the architecture 526), and ensuring that the input and encoding learned features are used in the final prediction. For example, structural integrity preservation may be helpful in preserving the simulation data's original geometrical information.

In the example illustrated in FIG. 5, the architecture 526 predicts a difference field (e.g., a displacement value difference, a difference between a start time layer deformation and a predicted target time layer deformation, etc.). A wrapping layer 544 may be utilized and the input layer 528 may be appended to produce the predicted sintering state 534. In some examples, the predicted sintering state 534 may be at a second time (e.g., t(k)). In some examples, the wrapping layer 544 may be a convolutional layer or another structure. In the example of FIG. 5, a spatial transformer layer may be utilized.

In some examples, a training objective function may be utilized to train a machine learning model or models described herein. In some examples, a similarity loss (e.g., Lₛᵢₘ) may be utilized to train a machine learning model to reduce (e.g., minimize) the differences of each pixel between the ground truth (e.g., I^{G}) and predicted displacement images (e.g., I^{P}) in accordance with Equation (1), where h denotes image “height” or number of pixel rows, i is an index (e.g., pixel row number), w denotes image “width” or number of pixel columns, and j is an index (e.g., pixel column number).

$${L}_{sim} = {\sum }_{i = 0}^{h} {\sum }_{j = 0}^{w} {‖ {I}_{ij}^{G} - {I}_{ij}^{P} ‖}_{2}^{2} \qquad ( 1 )$$

In some examples, I^{G} and/or I^{P} may be expressed as a scalar or scalars of one-dimension displacement or as a vector or vectors including a 3D (e.g., x, y, z) displacement value or values. In some examples, a displacement vector may represent voxel-level physics properties. In some examples, to measure and/or represent a quantitative displacement vector at each voxel (at a first time and a second time, for instance), an object may be sliced at a height (e.g., z-height). Each slice may represent voxel displacement as values (e.g., u, v, and w) corresponding to displacement in three dimensions (e.g., x, y, and z).

In some examples, a gradient loss (e.g., L_{gradient}) may be used (in addition to the similarity loss in some approaches). Since an image gradient may be used to extract information from images (e.g., edge or change of intensity in a given direction (x-direction or y-direction)), the gradient loss may be utilized to enforce the preservation of geometric shape. The gradient loss may be expressed as given in Equation (2).

$${L}_{gradient} = {\sum }_{i = 0}^{h} {\sum }_{j = 0}^{w} {‖ {dx}_{ij}^{G} - {dx}_{ij}^{P} ‖}_{2}^{2} + {\sum }_{i = 0}^{h} {\sum }_{j = 0}^{w} {‖ {dy}_{ij}^{G} - {dy}_{ij}^{P} ‖}_{2}^{2} \qquad ( 2 )$$

In Equation (2), dx^{G} denotes a ground truth gradient in an x direction, dx^{P} is a predicted gradient in the x direction, dy^{G} denotes a ground truth gradient in a y direction, and dy^{P} is a predicted gradient in the y direction.

In some examples, an overall objective function may be a weighted combination of the similarity loss and the gradient loss. The overall objective function (e.g., L) may be expressed in accordance with Equation (3).

$$L = {L}_{sim} + λ {L}_{gradient} \qquad ( 3 )$$

In Equation (3), λ is a weighting value. In some examples, a machine learning model or models described herein may be trained using the similarity loss, the gradient loss, and/or the overall loss.

FIG. 6 is a diagram illustrating an example of a machine learning architecture 658 that may be utilized in accordance with some examples of the techniques described herein. The architecture 658 in FIG. 6 includes a first plane machine learning model 652, a second plane machine learning model 654, and a third plane machine learning model 656. The first plane machine learning model 652 may be trained on the x-y plane, the second plane machine learning model 654 may be trained on the y-z plane, and the third plane machine learning model 656 may be trained on the x-z plane. The plane machine learning models may predict deformations in respective planes. For example, each plane machine learning model may make 2D displacement predictions for each voxel on different planes of 3D data. In some examples, each plane machine learning model may have an architecture similar to the architecture 526 described in relation to FIG. 5 or another architecture.

The first plane machine learning model 652 may utilize an x-y input 646. The second plane machine learning model 654 may utilize a y-z input 648. The third plane machine learning model 656 may utilize an x-z input 650. The predicted results 659 may be fed to a fusion network 660. In some examples, the fusion network 660 may be multilayer perceptron (MLP) layer network or another model. The output 662 of the fusion network may be a 3D sintering state (e.g., displacement in three-dimensional space).

In some examples, a loss function for training the fusion network 660 may be defined as the square of the norm of 3D displacement error: L=∥\vec{dₚ}−\vec{d_{g}}∥², where \vec{dₚ} denotes a predicted displacement and \vec{d_{g}} denotes a displacement of the ground truth. The fusion network 660 and the plane machine learning models (e.g., 2D deformation predictors) may be trained separately.

The architecture 658 described in relation to FIG. 6 may capture geometric information for each plane (e.g., all x, y, and z dimensions). The fusion network 660 may learn to combine the dimensional information, preserving the integrity across spatial dimensions.

In some examples, the machine learning model architecture 658 described in relation to FIG. 6 may be utilized for a machine learning model or machine learning models described in relation to FIG. 1, FIG. 2, FIG. 3, and/or FIG. 4. In some examples, other machine learning model architectures may be utilized in accordance with the techniques described herein. For instance, a variational auto encoder model architecture may be utilized in some examples.

Some examples of the techniques described herein may integrate a machine learning model (e.g., deep learning inferencing engine) as a component inside a physics based simulation engine to predict metal sintering deformation with increased speed and/or accuracy. In some examples, a machine learning model (e.g., deep learning model(s) and/or network architecture) may learn local material property composition and/or predict physics fields such as displacement vectors at a defined increment based on learned local and/or global material property composition. In some examples, a machine learning model (e.g., deep learning inferencing engine) may be integrated as part of a time-marching simulation.

In some examples, machine learning models that predict the rate of change of displacement (e.g., displacement “velocity”) may be utilized. For example, multiple velocity models may be trained and/or utilized that capture different sintering dynamics.

In some examples, the velocity models may take an input of period DT. The velocity models may allow predicting displacements of varying DT. At a time T0, an apparatus may trigger the velocity models to generate D0. An approach or approaches may be utilized to establish DT.

In some approaches, while the physics simulation engine marches with time, the physics simulation engine may generate a time series of a (DT, N) pair. DT is the period used and N is a number of iterations to utilize D0 to converge to De. In some examples, DT may be increased (e.g., maximized) under the constraints of a limited N. A machine learning model (e.g., time series regression model) can be developed based on the history. The machine learning model may be used to predict DT versus N as a trade-off for time T0, which may result in a choice of DT.

Some approaches using a (max(D0), N) pair may be used in some examples. A machine learning model (e.g., time series regression model) may be trained to allow predicting max(D0) versus N as a trade-off for time T0, which may result in a choice of max(D0). Depending on the velocity model, a DT may be calculated.

In some examples, an apparatus may deploy different machine learning models representing different sintering dynamics in parallel. The first converged result may produce De. Other trials with other machine learning models may be terminated. In some examples if no convergence is reached within a time threshold (e.g., within a quantity of iterations, within an actual amount of time, within 2 minutes, etc.), the parallel trials (e.g., all parallel trials) may be terminated. In this case, the period DT may be reduced (e.g., by half or another proportion) and the machine learning models (e.g., parallel trials) may be tried again.

While various examples of techniques are described herein, the techniques are not limited to the examples. Variations of the examples described herein may be implemented within the scope of the disclosure. For example, operations, functions, aspects, or elements of the examples described herein may be omitted or combined.

1. A method, comprising:
simulating, using a physics simulation engine, a first sintering state of an object at a first time; and
predicting, using a machine learning model, a second sintering state of the object at a second time based on the first sintering state, wherein a prediction increment between the first time and the second time is different from a simulation increment.

2. The method of claim 1, wherein respective machine learning models are trained for respective sintering stages.

3. The method of claim 2, wherein the machine learning model is utilized to predict the second sintering state in a first sintering stage, and wherein the method further comprises predicting, using a second machine learning model, a third sintering state of the object in a second sintering stage.

4. The method of claim 2, wherein the respective machine learning models are trained with different training data.

5. The method of claim 1, wherein the second sintering state indicates a displacement in a voxel space.

6. The method of claim 1, wherein the second sintering state indicates a displacement rate of change.

7. The method of claim 1, further comprising selecting the machine learning model or a second machine learning model based on a selection machine learning model.

8. The method of claim 1, further comprising:
predicting, using the machine learning model, a first candidate sintering state in a transition region;
predicting, using a second machine learning model, a second candidate sintering state in the transition region;
determining a first residual loss based on the first candidate sintering state and a second residual loss based on the second candidate sintering state; and
selecting the machine learning model or the second machine learning model based on the first residual loss and the second residual loss.

9. The method of claim 8, wherein:
determining the first residual loss comprises determining a first difference of the first candidate sintering state and a tuned sintering state;
determining the second residual loss comprises determining a second difference of the second candidate sintering state and the tuned sintering state; and
selecting the machine learning model or the second machine learning model comprises comparing the first residual loss and the second residual loss.

10. An apparatus, comprising:
a memory;
a processor in electronic communication with the memory, wherein the processor is to:
predict, using a first machine learning model, a first sintering state of an object;
predict, using a second machine learning model, a second sintering state of the object; and
select the first machine learning model or the second machine learning model based on the first sintering state, the second sintering state, and a tuned sintering state.

11. The apparatus of claim 10, wherein the processor is to tune the first sintering state or the second sintering state using a physics simulation engine to produce the tuned sintering state.

12. The apparatus of claim 10, wherein the first machine learning model is trained using training data that includes a simulated input sintering state at a start time, and a simulated output sintering state at a target time.

13. A non-transitory tangible computer-readable medium storing executable code, comprising:
code to cause a processor to predict a first plane sintering state using a first plane machine learning model;
code to cause the processor to predict a second plane sintering state using a second plane machine learning model;
code to cause the processor to predict a third plane sintering state using a third plane machine learning model; and
code to cause the processor to fuse the first plane sintering state, the second plane sintering state, and the third plane sintering state to produce a three-dimensional (3D) sintering state.

14. The computer-readable medium of claim 13, wherein the first plane machine learning model is an x-y machine learning model, the second plane machine learning model is a y-z machine learning model, and the third plane machine learning model is an x-z machine learning model.

15. The computer-readable medium of claim 13, wherein the code to cause the processor to fuse the first plane sintering state, the second plane sintering state, and the third plane sintering state is based on a fusing network.
